(19) United States
(12) Patent Application Publication
(10) Pub. No.: US 2005/0242999 A1
(43) Pub. Date: Nov. 3, 2005

(54) Low-profile unbalanced vehicular antenna methods and systems

(76) Inventor: Charles D. McCarrick, Plymouth, MA (US)

Correspondence Address: STRATEGIC PATENTS P.C.., C/O PORTFOLIOIP, P.O. BOX 52050, MINNEAPOLIS, MN, 55402, US

(21) Appl. No.: 11/106,018

(22) Filed: Apr. 14, 2005

Related U.S. Application Data
(60) Provisional application No. 60/562,857, filed on Apr. 16, 2004.

(51) Int. Cl. H01Q 1/38

(52) U.S. Cl. 343/700 MS

(57) ABSTRACT

A method and system of providing an antenna for a communications system is provided including providing a modular patch antenna having a substantially omni-directional gain pattern. A gain modifying facility provides for modification of the gain pattern along at least one s selected axis of the antenna. The modular patch antenna is for a mobile platform having a direction of motion where the gain pattern creates a substantially elliptical gain pattern. The gain is increased along an axis substantially perpendicular to the direction of motion.

### CROSS-REFERENCE TO RELATED APPLICATION

This application claims the benefit of U.S. Prov. App. No. 60/562,857, filed Apr. 16, 2004 and entitled “LOW-PROFILE UNBALANCED VEHICULAR ANTENNA METHODS AND SYSTEMS,” the entire disclosure of which is incorporated herein by reference.

### BACKGROUND

1. Field

This invention relates to methods and systems for making and using modular patch antennas and more generally to the field of enhancing audio and data signal reception from both terrestrial and satellite transmitters.

2. Description of the Related Art Satellite Digital Audio Radio Services (SDARS), such as those provided by Sirius Satellite Radio Inc. and XM Satellite Radio, Inc, are examples of a wireless content delivery system implementation that uses both satellite and terrestrial transmitters to deliver audio and data content to users located at various parts of a service area. In such systems, the receiver usually works with satellite signals in rural areas, and, where terrestrial transmitters are located, with terrestrial signals, most typically in urban areas. Generally, satellites are visible to receiver antennas when the satellites are at or above a particular elevation angle in the sky, such as about 20° to 90° of elevation. The terrestrial networks are typically visible to receiver antennas at or below a certain angle of elevation, typically at or below 10° of elevation in the horizontal direction.

The SDARS systems typically provide various broadcast content delivery services over a large system service area, e.g. CONUS (the mainland United States). Content may be audio, data, or other electronic content. Signal delivery to subscribing receivers within a system service area is typically made simultaneously by two networks, a geo-stationary or geo-synchronous satellite network and a ground-based terrestrial signal delivery network.

Despite the benefits of these two systems in covering different elevation angles, further improvements are desired. Mobile receivers frequently lose the signal from both the satellite network and the terrestrial network, resulting in failure of content delivery. A particular problem exists as a result of blocking or shading of signals in directions that are perpendicular to the motion of a vehicle on which the antenna is positioned. In the direction of motion, the view to the sky is often relatively clear, as it is taken up by flat roadway, rather than objects, even in urban environments. On the other hand, at the sides of the vehicle, buildings, trees, geographic features, towers, and other structures often block signals from satellite and terrestrial systems. Accordingly, a need exists for performance improvements for SDARS content delivery systems, particularly for performance improvements in receiving signals coming from the side of a vehicle relative to its direction of motion.

### SUMMARY

Provided herein are methods and systems for providing an antenna for a communications system with a modular patch antenna having a substantially omni-directional gain pattern. A gain modifying facility modifies the gain pattern along at least one selected axis of the antenna, creating a substantially elliptical gain pattern. The antenna may be for a mobile platform having a direction of motion, and the gain may be preferentially increased along an axis substantially perpendicular to the direction of motion, such as toward the sides of a moving automobile. In embodiments, the modified gain pattern may have an elliptical shape. The gain may be increased in the 90° and 270° horizontal azimuth directions, and the gain may be relatively decreased in the 0° and 180° directions. The antenna gain pattern seen by the user terminal can have a circularly polarized gain providing more favorable satellite signal reception performance in the plane of the major axis of the antenna placement.

In an embodiment the gain modifying facility may be a second modular patch antenna that may be a parasitic patch antenna. The first patch and the second patch may be positioned on a dielectric substrate or may be positioned on the same dielectric substrate. The first patch and the second patch may each have an angle of rotation relative to the substrate. In embodiments, the angles of rotation of the two patches may be the same, or the angles of rotation of the two patches may be different.

In embodiments the antenna may receive data from a terrestrial transmitter, a satellite transmitter, or terrestrial and satellite transmitters. The antenna may receive signals in a range suitable for radio communications, signals in a range of frequencies between about 2320 MHz and 2345 MHz or in some cases greater ranges, signals in a range suitable for television signal communications, or signals in a range suitable for data communications, such as text messages, Internet content, electronic mail, and other data.

In one embodiment the antenna gain pattern may be configured to be elliptical, with the major axis of the ellipse being along a line from 0°-180°. The antenna gain pattern can be monotonic in both the 0°-180° and the 90° -270° elevation planes. In another embodiment the two patch antennas may be placed along the 0°-180° axis to orientate the elliptical major axis along a line from 90°-270°.

In an embodiment the patches of the modular patch antenna may be constructed of a radiating layer, a dielectric layer, and a ground layer. The radiating layer may be a metal layer or may be a metal plate layer. The radiating layer may be any radiating metal, such as a metal selected from the group consisting of Ag, Au, Cu, Ni, and Al. In embodiments, the radiating layer may have a length between about 30 mm and about 60 mm and may have a width of about 30 mm to about 60 mm. The dielectric layer for the first patch and second patch may be any dielectric material, such as one selected from the group consisting of Teflon, PTFE (polytetrafluoroethylene), glass, ceramic, aluminum, polymers, silica, radiated polyolefin, and quartz. In embodiments the dielectric layer may have a height of between 1 mm and 5 mm and may have a width between 35 mm and 65 mm. The ground layer may be one of a metal or a metal plate, such as one selected from the group consisting of Ag, Au, Cu, Ni and Al. The ground layer may have a width between about 35 mm and about 65 mm and may have a length between about 45 mm and about 75 mm. The width of each of the three layers may be substantially the same. The width of each of the three layers may be between about 30 mm and about 70 mm. The antenna may be square, rectangular, round, circular, elliptical, a truncated circle, or other appropriate shape.

The first patch may be electrically connected to the user terminal. The second patch may be used in order to deform the antenna gain pattern of the first patch from having an omni-directional gain in azimuth to having a modified gain pattern. The second patch may be placed towards the direction of desired gain increase, and this may provide a circularly polarized gain that may be more favorable to satellite signal reception performance. The gain pattern may be such that the gain is increased towards the 90° and 270° directions and the gain in the 0° and 180° directions may be decreased. The modified gain pattern may affect volume shifts toward lower elevation angles where the terrestrial transmitter signals arrive at less than ten degrees.

Each patch may be a truncated circle having four segments. Two opposite segments of the patch may be parallel line segments while the two opposite segments of the patch may be segments of a circle. Modifying parameters of the first patch, the second patch and the substrate that can impact the gain pattern of the antenna can include the spacing between patches S, the rotation angle of the second patch α, the dielectric constant of the substrate εᵣ, the radius of the first patch r, and the radius of the second patch rₚ. The parameters may be varied to alter the resulting gain patterns. The physical separation of the first patch and the second patch may be fixed so as to establish a desired gain pattern response.

In one embodiment the antenna modification parameters εᵣ, S, r_{d}, rₚ, and α° may provide an elliptical gain pattern. The parameters may be εᵣ=2.32, S=2.25, r_{d}=rₚ=1.81 inches, and α=0° rotation. These parameters may provide a higher gain that may be at the 90° and 270° direction for elevation angles above 45° where the majority of the SDARS satellites may be seen by the mobile platform while being shadowed by local objects. The gain may be increased at the 90° and 270° direction of the mobile platform for, elevation angles around 0°, where the majority of the terrestrial SDARS repeater signals may arrive to the mobile platform while being shadowed by local objects.

In another embodiment the antenna modification parameters εᵣ, S, r_{d}, rₚ, and α° may provide a different elliptical gain pattern. The parameters may be εᵣ=2.32, S=2.5, r_{d}=0.94 inches, rₚ=1.71 inches, and α=7.50 rotation. These parameters may provide higher gain at the 90° and 270° direction for elevation angles above 45° and may provide terrestrial gain equal at around 0° at all azimuth angles in the 0°, 90°, 180° and 270° direction. This may provide higher terrestrial gain from the SDARS repeaters at all azimuth directions where the terrestrial signals may be blocked by local blocking and shadowing environments in all directions.

In an embodiment the modular patch antenna may have a vertically polarized gain, at about 0° elevation angle, of at least about −10 dbic in circular polarization, with a resulting vertical polarization of about −7 dBi. The gain of the modular patch antenna may have increased circularly polarized gain in the 90° and 270° directions, at 50°, to about +5.5 to +6.5 dBic. The modular patch antenna forms the unbalanced gain pattern in azimuth.

In an embodiment the modular patch antenna gain pattern may have a vertically polarized gain, at elevation angles of less than 10°, in the range of about +0.5 to +1 dBi and may provide favorable terrestrial signal reception. The favorable directions may be 0° and 180° directions where the terrestrial signals are expected to arrive in local blocking and shadowing environments.

In an embodiment the modular patch antenna gain pattern may be shaped so that it provides equal vertically polarized gain at all azimuth directions for elevation angles of less than 10°, in the range of about +0.5 to +1 dBi. This may also provide higher gain at 90° and 270° directions for elevations higher than 45°, which may provide improved reception from SDARS satellites while in the blocking and shadowing environments.

In an embodiment the modular patch antenna may comprise a plurality of patch antennas configured so as to establish a desired radiation pattern response. The gain pattern may be fixed or the gain pattern may be modifiable by the user from the terminal interface or the modular patch antenna may automatically modify the gain. The modular patch antenna may automatically select the optimal orientation for the first patch and the second patch.

In an embodiment the modular patch antenna may be integral with the receiver. The modular patch antenna may be internal to the receiver or may be external to the receiver. In an embodiment the modular patch antenna may be retrofitted to an existing receiver. The existing antenna may be removed and replaced by the modular patch antenna or the existing antenna may be used in addition to the modular patch antenna. The modular patch antenna may be connected using the existing interface device of the existing receiver or a new interface device may used to connect to the existing receiver.

The modular patch antenna may be integral to a transmission service where the service is optimized to use the modular patch antenna to take advantage of the improved reception in blocking and shadowing environments. Satellite transmission may be optimized for the modular patch antenna and the terrestrial transmission may be optimized for the modular patch antenna. The service may be transmitted in multiple formats such as audio transmission, television transmission, data transmission, telephone transmission, or other aerial signal transmission.

It should be appreciated that all combinations of the foregoing concepts and additional concepts discussed in greater detail below are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE FIGURES

The invention may be understood by reference to the following figures:

FIG. 1 shows the embodiment of a first module of a single patch antenna gain pattern.

FIG. 2 illustrates the construction of a single patch antenna.

FIG. 3 shows the typical blockage scenario in an urban environment.

FIG. 4 illustrates a modular patch antenna and modifying parameters.

FIG. 5 shows the embodiment of the first and second modules of a modular patch antenna gain pattern.

FIG. 6 illustrates the embodiment of 2-D cuts of a gain pattern that the modular antenna of FIG. 5 would provide.

FIG. 7 shows a gain plot with the azimuth perpendicular planes.

FIG. 8 shows a gain plot with the azimuth perpendicular planes but with the gains equalized.

FIG. 9 shows the modular antenna parameters modified by the user terminal.

FIG. 10 shows the modular antenna parameters automatically modified by modular patch antenna.

FIG. 11 shows the modular patch antenna as internal to the receiver.

FIG. 12 shows the modular patch antenna as external to the receiver.

### DETAILED DESCRIPTION

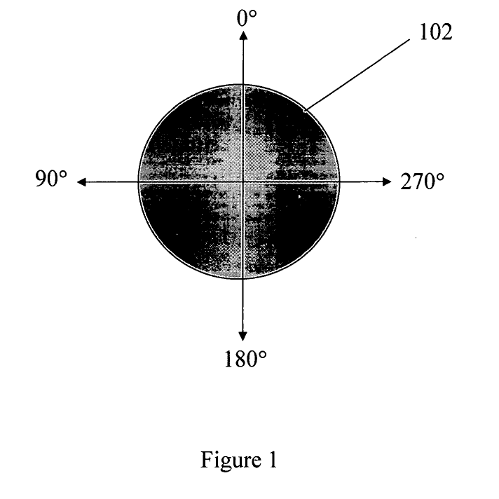

Referring to FIG. 1, a gain pattern for a typical single patch antenna is shown, with a substantially omni-directional gain pattern providing equal gain 102 in all azimuth directions. With the gain pattern, if signals are weak in a particular direction, such as because they are blocked by trees, buildings, or the like, the signals will be lost.

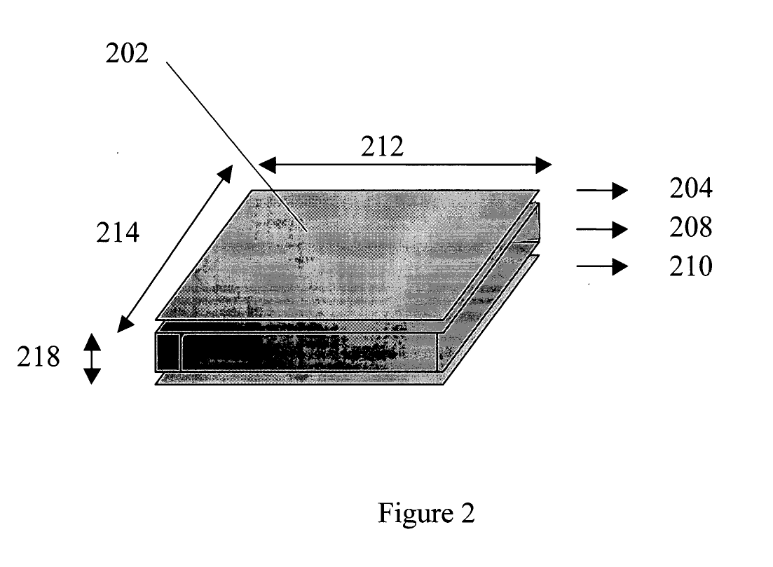

Referring to FIG. 2, a modular patch 202 for an SDARS antenna is made up of at least a radiating layer 204, a middle dielectric layer 208, and a ground plane 210. The radiating layer 204 may be a metal layer a metal plate layer. The radiating layer 204 is typically made of a radiating metal, such as Ag, Au, Cu, Ni, or Al. In one preferred embodiment, the radiating metal is copper. The radiating layer 204 may have a length 212 between about thirty mm and width 214 of about sixty mm, although other dimensions also work if antennas of different sizes or total gain are desired. The dielectric layer 208 for the modular patch 202 may be any suitable dielectric, such as Teflon, PTFE (polytetrafluoroethylene), glass, ceramic, aluminum, polymers, silica, radiated polyolefin, or quartz. In one preferred embodiment, the dielectric layer is aluminum. The dielectric layer 208 may have a height 218 of between one mm and five mm. The dielectric layer 208 may have a width 214 between thirty-five mm and sixty-five mm. The ground plane 210 may be of a metal and a metal plate, such as consisting of Ag, Au, Cu, Ni or Al. The ground plane 210 may have a width 214 between about thirty-five mm and about sixty-five mm. The ground plane 210 may have a length between about forty-five mm and about seventy-five mm 212. The width 214 of each of the radiating layers 204, dielectric layer 208, and ground plane 210 is substantially the same. The width 214 of the radiating layers 204, dielectric layer 208, and ground layer 210 may be between about thirty mm and about seventy mm.

In embodiments, the patch 202 can take many different shapes. For example, the patch 202 can be square, rectangular, round, circular, elliptical, a truncated circle, or another appropriate shape.

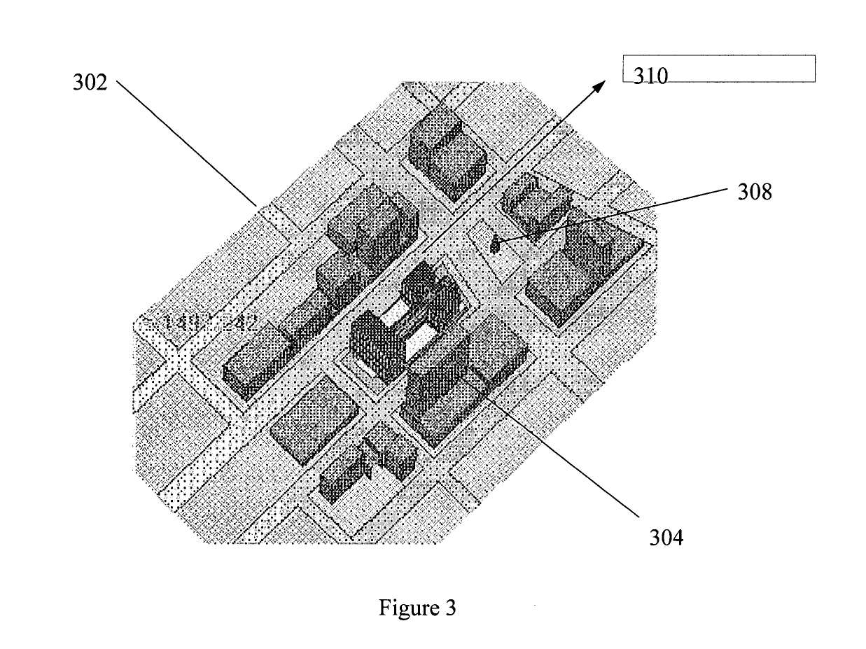

Referring to FIG. 3, in embodiments the antenna is for a mobile platform having a direction of motion 310, such as a car, bus or other vehicle traveling along a street. The modular patch antenna 202 of FIG. 2 may provide a circularly polarized gain that provides more favorable satellite signal reception performance in areas where the signals are obstructed, such as urban areas. The area around a platform may have buildings 304, trees 308, or other solid and semi solid objects that may block satellite and terrestrial signals. The buildings 304, trees 308 or other obstructions may block SDARS satellite and terrestrial signals coming from directions perpendicular to the range of motion. Thus, rather than the omni-directional gain pattern of FIG. 1, it is desirable to have a gain pattern that extends more in the direction that is perpendicular to the direction of motion, to account for the greater obstruction of signals coming in that direction.

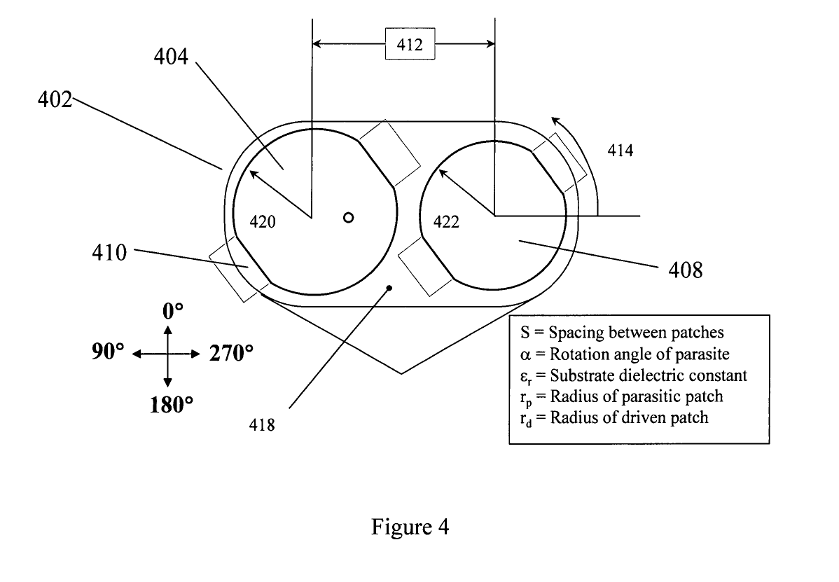

Referring to FIG. 4, a second modular patch 408 may serve as a gain modifying facility 402 for modifying the gain of a first patch antenna 404. The second modular patch 402 may be a parasitic patch antenna 408. The first patch 404 and the second patch 408 may both be positioned on a dielectric substrate 410. The first patch 404 and the second patch 408 may be positioned on the same dielectric substrate 410. The first patch 404 and the second patch 408 each may have an angle of rotation relative to the substrate 410. Each of the first patch 404 and the second patch 408 may have a defined angle of rotation relative to the substrate 404. In embodiments, such as depicted in FIG. 4, the angle of rotation is the same for both the first patch antenna 404 and the second patch antenna 408. Alternatively, the second patch 408 may have a different angle of rotation than the first patch 404 relative to the substrate.

The performance of the modular patch antenna 402 may be adjusted by modifying various parameters as shown in FIG. 4. Those parameters include parameters relating to the first patch 404, the second patch 408 and the substrate 410. For example, the spacing between patches, S, 412 can be adjusted. It is also possible to adjust the rotation angle, α, 414 of the second patch 408 relative to the angle of the first patch 404. Another parameter that can be varied is the dielectric constant εᵣ 418 of the substrate 410. Also, one can adjust the radius r_{d} 420 of the first patch 404 and radius rₚ 422 of the second patch 408. All of these parameters affect the gain pattern of the modular patch antenna 402.

The parameters may be varied to alter the resulting gain patterns. The physical separation of the first patch 404 and the second patch 408 may be fixed so as to establish a desired gain pattern response.

For example, the first patch 404 and the second patch 408 may be a truncated circle having four segments. The two opposite segments of the patch may be parallel line segments. The two opposite segments of the patch may segments of a circle.

The second patch 408 may be placed towards the direction of desired gain increase. The modular patch antenna may comprise a plurality of patch antennas configured so as to create a desired radiation pattern response. For example, two, three, four or more patch elements might be used to produce a desired gain pattern.

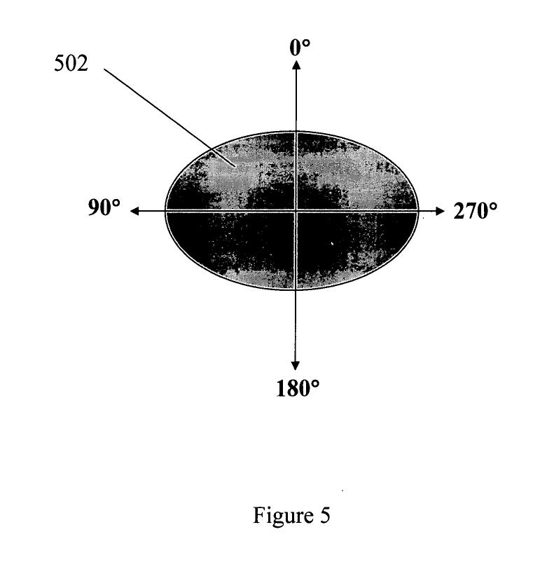

Referring to FIG. 5, given the presence of obstructions in the direction perpendicular to the direction of motion, it is desirable to have a stronger gain in that direction. FIG. 5 shows a deformed gain pattern 502 that can result by adding the second patch 408 to the first patch 404 in the antenna 402. The second patch 408 is used in order to deform the antenna gain pattern of the original single-module antenna from having an omni-directional gain in azimuth to having an Is elliptical gain pattern 402.

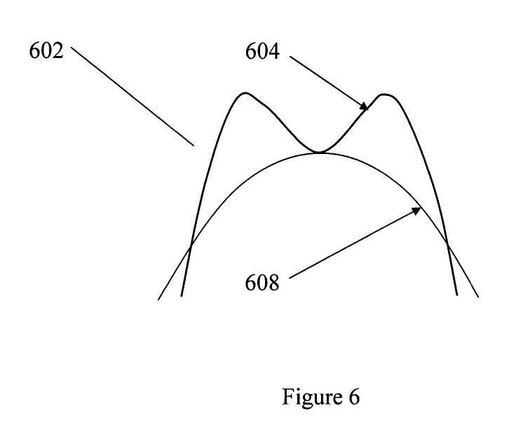

Referring to FIG. 6, an example gain pattern 602 that may be realized by the modular patch antenna is shown in 2D cuts of the gain pattern in two orthogonal directions. A gain increase would be obtained towards the 90° and 270° directions 604 where blocking and shadowing environments may occur. The gain in the 0° and 180° 608 directions would decrease, and some volume shift would occur towards the lower elevation angles. The SDARS terrestrial transmitter signals are received by the user terminal at elevations less than 10° .

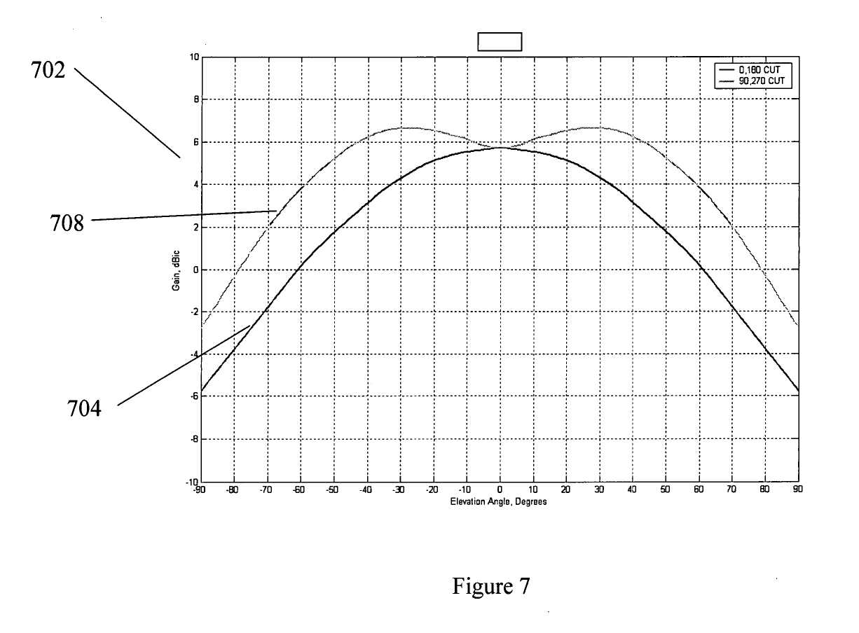

Referring to FIG. 7, the modification parameters εᵣ 418, S 412, r_{d} 420, rₚ 422, and α° 414 may provide an elliptical gain pattern 702. With the parameters set to εᵣ418 =2.32, S 412=2.25, r_{d}420=rₚ422=1.81 inches, and α 414=0° rotation the higher gain may be at the 90° and 270° direction 708 for elevation angles above 45° where the majority of the SDARS satellites may be seen by the mobile platform while being shadowed by local objects. The higher gain may be at the 90° and 270° direction 708 of the mobile platform for elevation angles around 0°, where the many terrestrial SDARS signals arrive to the mobile platform while being shadowed by local objects. The 0° and 180° 704 directions are shown to have a reduced gain.

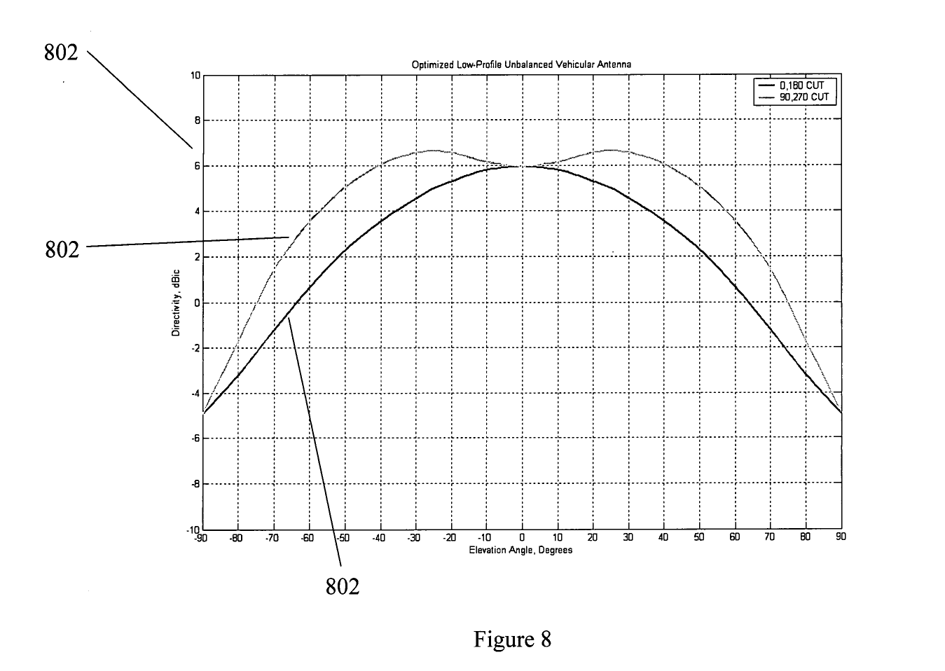

Referring to FIG. 8, the modification parameters εᵣ418, S 412, r_{d} 420, rₚ 422, and α° 414 may provide an elliptical gain pattern 802. With the parameters set to εᵣ=2.32, S =2.5, r_{d}=0.94 inches, rₚ=1.71 inches, and α=7.5° rotation. The higher gain at the 90° and 270° direction 802 for elevation angles above 45° is slightly lowered in order that the terrestrial gain may be equal at around 0° at all azimuth angles at the 0°, 90°, 180° and 270° direction where the terrestrial signals may be blocked by local blocking and shadowing environments. The 0° and 180° directions 802 are shown to have a reduced gain.

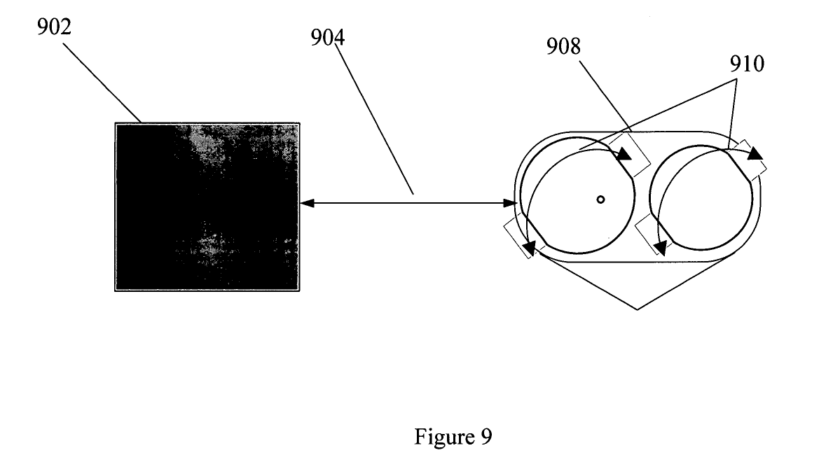

Referring to FIG. 9, in embodiments, the gain pattern of the modular patch antenna 908 may be modifiable 910, such as from the interface 904 of the terminal 902. The gain may be modified 910 by the user from the terminal 902 by providing input as to the modifying parameters in use at a given time. The user may be able to manually or automatically control the gain pattern for optimum reception by adjusting the user terminal 904. In one preferred embodiment the gain pattern is determined at the factory, by setting the desired parameters at the time of manufacturing. In other embodiments, the gain pattern can be field-adjusted, such as to rotating the patches. In other embodiments, a motor or similar facility may be used to rotate or move the second patch to adjust the relative gain pattern. Thus, the user terminal 902 may include a user interface for adjusting a parameter of the antenna 402.

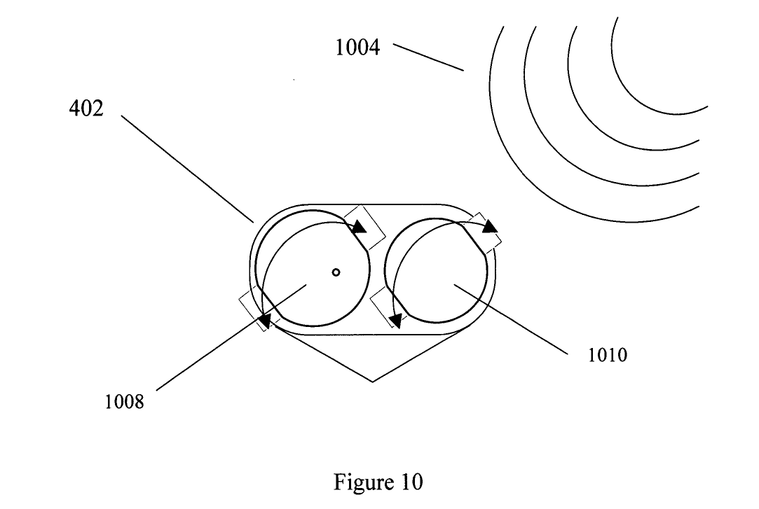

Referring to FIG. 10, in embodiments the modular patch antenna 402 may automatically select the optimum modifying parameter setting for the modular patch antenna 402 based on the signal strength received 1004. This may be independent of input from the user terminal. In such embodiments, the modular patch antenna 1002 selects the optimal orientation for the first patch 1008 and the second patch 1010, such as through a feedback loop or similar facility that is based on the signal strength from the satellite signal, the terrestrial signal, or both.

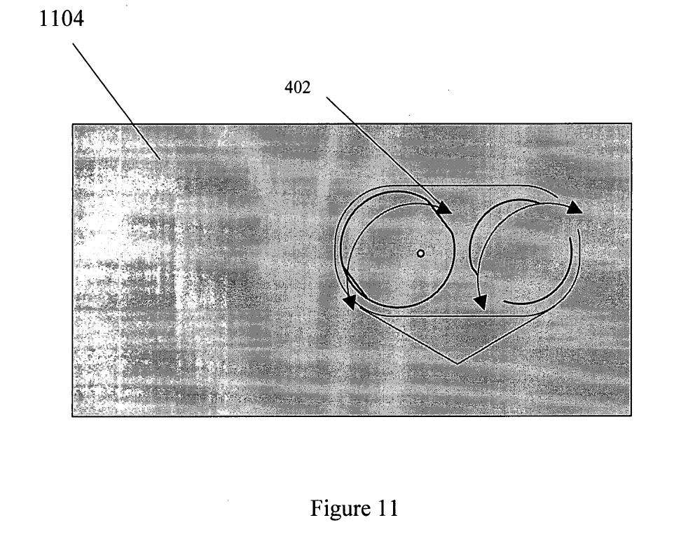

Referring to FIG. 11, the modular patch antenna 402 may be integrated with a communications facility, such as a receiver 1104. The modular patch antenna 402 may be internal to the receiver 1104. The receiver 1104 may be a receiver for a satellite radio system, a terrestrial radio system, a video system, a television system, a data system, a wireless network, an email system, a pager system, an instant messaging system, a text messaging system, or other system.

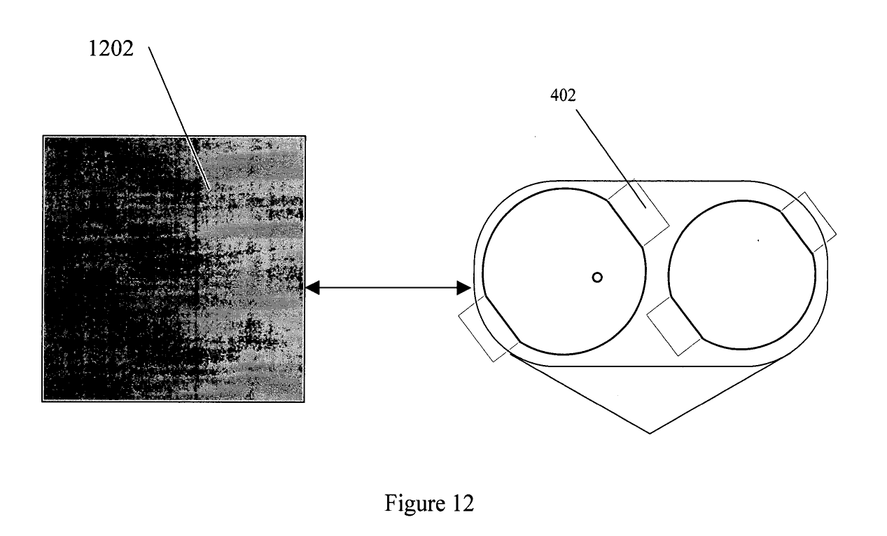

Referring to FIG. 12, the modular patch antenna 402 may be in communication with an external receiver 1202. In such embodiments, the modular patch antenna 402 may be external to the receiver 1202.

While the invention has been described in connection with certain preferred embodiments, other embodiments may be recognized by one of ordinary skill in the art and are encompassed herein, as limited only by the claims.

1. A method of providing an antenna for a communications system, comprising:
providing a modular patch antenna having a substantially omni-directional gain pattern; and
providing a gain modifying facility for modifying the gain pattern along at least one selected axis of the antenna.

2. (canceled)

3. A method of claim 1 wherein the antenna is for a mobile platform having a direction of motion.

4-6. (canceled)

7. A method of claim 1, wherein the gain modifying facility is a second modular patch antenna.

8. (canceled)

9. A method of claim 7, wherein the first patch and the second patch are positioned on a dielectric substrate.

10-13. (canceled)

14. A method of claim 7, further comprising modifying a parameter of the first patch, the second patch and the substrate, wherein the parameter is selected from the group consisting of spacing between patches S, rotation angle of the second patch a, dielectric constant of the substrate εᵣ, radius of the first patch r, and radius of the second patch.

15-19. (canceled)

20. A method of claim 1, wherein the antenna is configured to receive data from a terrestrial transmitter.

21. A method of claim 1, wherein the antenna is configured to receive data from a satellite transmitter.

22-26. (canceled)

27. A method of claim 1, wherein the antenna gain pattern seen by a user terminal has a circularly polarized gain providing more favorable satellite signal reception performance in the plane of the major axis of the antenna placement.

28. A method of claim 1, wherein the antenna gain pattern is elliptical.

29-58. (canceled)

59. A method of claim 7, wherein the second patch is used in order to deform the antenna gain pattern of the original single-module antenna from having an omni-directional gain in azimuth to having a modified gain pattern.

60-98. (canceled)

99. An antenna system for a communications system, comprising:
a modular patch antenna having a substantially omni-directional gain pattern; and
a gain modifying facility for modifying the gain pattern along at least one selected axis of the antenna.

100. (canceled)

101. A system of claim 99 wherein the antenna is for a mobile platform having a direction of motion.

102-104. (canceled)

105. A system of claim 99, wherein the gain modifying facility is a second modular patch antenna.

106-107. (canceled)

108. A system of claim 107, wherein the first patch and the second patch are positioned on the same dielectric substrate.

109-111. (canceled)

112. A system of claim 105, further comprising a modifying facility for modifying a parameter of the first patch, the second patch and the substrate, wherein the parameter is selected from the group consisting of spacing between patches S, rotation angle of the second patch α, dielectric constant of the substrate εᵣ radius of the first patch r, and radius of the second patch. rₚ.

113-117. (canceled)

118. A system of claim 99, wherein the antenna is configured to receive data from a terrestrial transmitter.

119. A system of claim 99, wherein the antenna is configured to receive data a satellite transmitter.

120-124. (canceled)

125. A system of claim 99, wherein the antenna gain pattern seen by a user terminal has a circularly polarized gain providing more favorable satellite signal reception performance in the plane of the major axis of the antenna placement.

126. A system of claim 99, wherein the antenna gain pattern is elliptical.

127-156. (canceled)

157. A system of claim 105, wherein the second patch is used in order to m the antenna gain pattern of the original single-module antenna from having an omni-directional gain in azimuth to having a modified gain pattern.

158-196. (canceled)
